(19) United States
(12) Patent Application Publication
(10) Pub. No.: US 2025/0172584 A1
(43) Pub. Date: May 29, 2025

(54) ACCELEROMETER INCLUDING SINGLE MAGNET

(71) Applicant: Honeywell International Inc., Charlotte, NC (US)

(72) Inventor: Paul W. Dwyer, Seattle, WA (US)

(21) Appl. No.: 18/519,898

(22) Filed: Nov. 27, 2023

(51) Int. Cl. G01P 15/13; G01P 1/04; G01P 15/125

(52) U.S. Cl. CPC G01P 15/132; G01P 1/04; G01P 15/125

(57) ABSTRACT

An accelerometer system includes a magnet having a first end and a second end opposite the first end. The magnet is configured to generate a magnetic flux that flows through the magnet from the second end of the magnet to the first end of the magnet a proof mass extending through the magnet. The accelerometer system also includes a first coil disposed around a first portion of the magnet, a second coil disposed around a second portion of the magnet, and processing circuitry. The processing circuitry is configured to receive a signal corresponding to a capacitance of an interface between the magnet and the proof mass, cause a first current to flow through the first coil, and cause a second current to flow through the second coil. A first Lorentz force and a second Lorentz force maintain the proof mass in a null position.

### TECHNICAL FIELD

This disclosure relates to accelerometers.

### BACKGROUND

Accelerometers function by detecting a displacement of a proof mass under inertial forces. Some accelerometers include a capacitive pick-off system. For example, electrically conductive material (e.g., a capacitor plate) may be deposited on the upper surface of the proof mass, and similar electrically conductive material may be deposited on the lower surface of the proof mass. An acceleration or force applied along the sensitive axis of the accelerometer causes the proof mass to deflect either upwardly or downwardly causing the distance (e.g., a capacitive gap) between the pick-off capacitance plates and upper and lower non-moving members to vary. This variance in the capacitive gap causes a change in the capacitance of the capacitive elements, which is representative of the displacement of the proof mass along the sensitive axis. The change in the capacitance may be used as a displacement signal, which may be applied to a servo system that includes one or more electromagnets (e.g., a force-rebalancing coil) to return the proof mass to a null or at-rest position.

### SUMMARY

In general, the disclosure is directed to devices, systems, and techniques for determining an acceleration of one or more devices. Accelerometer systems that use electromagnetic forces to counteract proof mass displacement, also referred to as torque rebalance accelerometers or force rebalance accelerometers, may be affected by one or more electromagnetic phenomena. For example, hysteresis may be present when a change in one electromagnetic parameter causes a change in another magnetic parameter such that a behavior of the system depends on the history of the system. One example of hysteresis is a relationship between a magnetic field strength and a magnetization of a magnetic material. This relationship between magnetic field strength and magnetization may be associated with a minor loop slope indicating a sensitivity of the magnetization of the magnetic material to changes in magnetic field strength.

Some accelerometers include a proof mass and two magnets, where a first magnet is located on a first side of the proof mass and a second magnet is located on a second side of the proof mass. An accelerometer including two magnets may include a magnetic pathway for each of the magnets and an electrical coil for each of the magnets. Each pair of electrical coil and magnet may generate a Lorentz force that acts on the proof mass to maintain the proof mass in a null position. It may be beneficial in dual-magnet accelerometers for the magnets to have identical or nearly identical minor loop slopes. This is because when two magnets do not respond in the same way to changes in magnetic field, the two sides of the accelerometer might become imbalanced in a way that decreases an accuracy of the accelerometer.

The techniques of this disclosure may provide one or more advantages. For example, an accelerometer may include a single magnet located on both sides of a proof mass instead of including separate magnets on either side of the proof mass. The single magnet might have one minor loop slope throughout the magnet, meaning that a first portion of the single magnet on a first side of the proof mass may have the same minor loop slope as a second portion of the single magnet on a second side of the proof mass. This means that using a single magnet located on both sides of the proof mass may increase an accuracy of the accelerometer as compared with accelerometers that use two magnets, because dual magnet accelerometers may have differing minor loop slopes that introduce an imbalance across the proof mass whereas single magnet accelerometers have identical minor loop slope on either side of the proof mass.

In some examples, an accelerometer system includes a magnet having a first end and a second end opposite the first end. The magnet is configured to generate a magnetic flux that flows through the magnet from the second end of the magnet to the first end of the magnet. The accelerometer system also includes a proof mass extending through the magnet, a first coil disposed around a first portion of the magnet, and a second coil disposed around a second portion of the magnet. Additionally, the accelerometer system includes processing circuitry configured to receive a signal corresponding to a capacitance of an interface between the magnet and the proof mass, cause, based on the signal, a first current to flow through the first coil, and cause, based on the signal, a second current to flow through the second coil. A first force corresponding to the magnetic flux and the first current and a second force corresponding to the magnetic flux and the second current maintain the proof mass in a null position.

In some examples, an accelerometer system includes a magnet having a first end and a second end opposite the first end, wherein the magnet is configured to generate a magnetic flux that flows through the magnet from the second end of the magnet to the first end of the magnet. The accelerometer system also includes a proof mass extending through the magnet and a coil disposed around a portion of the magnet. Additionally, the accelerometer system includes processing circuitry configured to receive a signal corresponding to a capacitance of an interface between the magnet and the proof mass and cause, based on the signal, a current to flow through the coil, wherein a force corresponding to the magnetic flux and the current maintain the proof mass in a null position.

In some examples, a method includes receiving, by processing circuitry, a signal corresponding to a capacitance of an interface between a magnet and a proof mass, wherein the magnet extends from a first end of the magnet to a second end of the magnet, wherein the magnet is configured to generate a magnetic flux that flows through the magnet from the second end of the magnet to the first end of the magnet, wherein the proof mass extends through the magnet, wherein a first coil is disposed around a first portion of the magnet, and wherein a second coil is disposed around a second portion of the magnet. The method also includes causing, by the processing circuitry based on the signal, a first current to flow through the first coil; and causing, by the processing circuitry based on the signal, a second current to flow through the second coil, wherein a first force corresponding to the magnetic flux and the first current and a second force corresponding to the magnetic flux and the second current maintain the proof mass in a null position.

The summary is intended to provide an overview of the subject matter described in this disclosure. It is not intended to provide an exclusive or exhaustive explanation of the systems, device, and methods described in detail within the accompanying drawings and description below. Further details of one or more examples of this disclosure are set forth in the accompanying drawings and in the description below. Other features, objects, and advantages will be apparent from the description and drawings, and from the claims.

### BRIEF DESCRIPTION OF DRAWINGS

FIG. 1 is a block diagram illustrating an accelerometer system, in accordance with one or more techniques of this disclosure.

FIG. 2 is a conceptual diagram illustrating a side cutaway view of an accelerometer system, in accordance with one or more techniques of this disclosure.

FIG. 3A is a conceptual diagram illustrating a first horizontal cutaway view of the accelerometer system of FIG. 2, in accordance with one or more techniques of this disclosure.

FIG. 3B is a conceptual diagram illustrating a second horizontal cutaway view of the accelerometer system of FIG. 2, in accordance with one or more techniques of this disclosure.

FIG. 3C is a conceptual diagram illustrating a third horizontal cutaway view of the accelerometer system of FIG. 2, in accordance with one or more techniques of this disclosure.

FIG. 4 is a conceptual diagram illustrating a magnetic field strength throughout a cross-section of the accelerometer system of FIG. 2, in accordance with one or more techniques of this disclosure.

FIG. 5 is a flow diagram illustrating an example operation for determining an acceleration using an accelerometer including a single magnet, in accordance with one or more techniques of this disclosure.

Like reference characters denote like elements throughout the description and figures.

### DETAILED DESCRIPTION

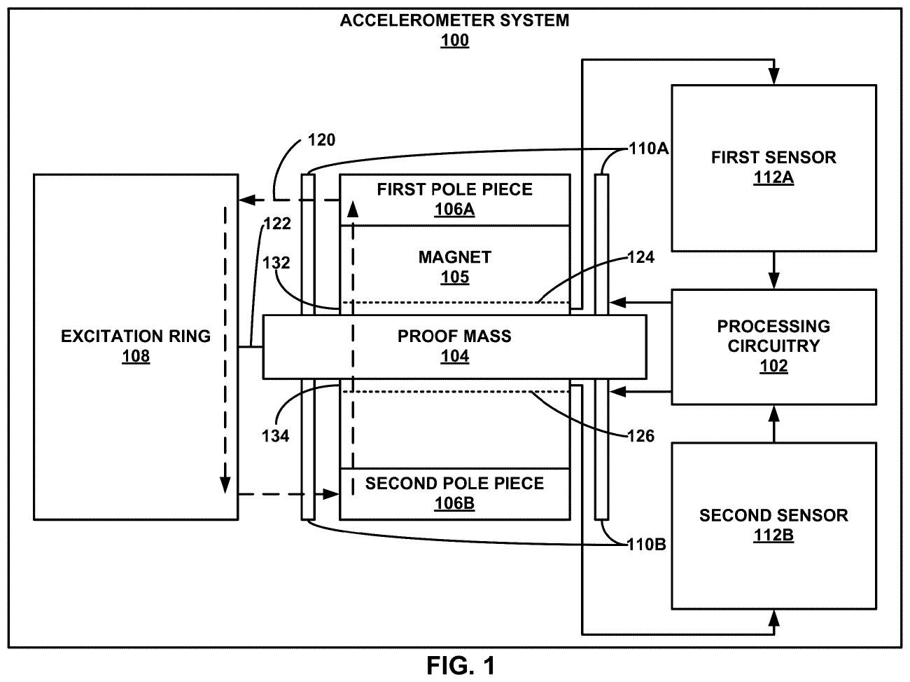

FIG. 1 is a block diagram illustrating an accelerometer system 100, in accordance with one or more techniques of this disclosure. As illustrated in FIG. 1, accelerometer system 100 includes processing circuitry 102, proof mass 104, magnet 105, first pole piece 106A, second pole piece 106B (collectively, “pole pieces 106”), excitation ring 108, coil 110A, coil 110B (collectively, “coils 110”), first sensor 112A, and second sensor 112B (collectively, “sensors 112”), and connector 122.

Accelerometer system 100 is configured to determine an acceleration associated with an object (not illustrated in FIG. 1) corresponding to accelerometer system 100 based on a magnitude of one or more electrical signals delivered to coils 110 to maintain proof mass 104 in a null position. For example, processing circuitry 102 may generate a first electrical signal for delivery to coil 110A and may generate a second electrical signal for delivery to coil 110B. The first electrical signal and the second electrical signal may induce one or more Lorentz forces which prevent the displacement of proof mass 104 from a null position. In some examples, the first electrical signal and the second electrical signal represent one electrical signal flowing through a single current pathway formed by coil 110A and coil 110B. That is, processing circuitry may generate a single electrical signal to flow through the single current pathway formed by coil 110A and coil 110B.

A Lorentz force represents a force caused by an interaction of an electric field and a magnetic field. For example, a Lorentz force may be defined by a cross-product of an electrical field and a magnetic field, where the direction of the Lorentz force depends on the direction of the electrical field and the direction of the magnetic field, and where the magnitude of the Lorentz force depends on the magnitude of the electrical field and the magnitude of the magnetic field. When an object associated with accelerometer system 100 is accelerating, it may be necessary to deliver Lorentz forces equal and opposite to an acceleration force acting on the proof mass 104 in order to maintain the proof mass 104 in the null position. Consequently, processing circuitry 102 may determine the acceleration of accelerometer system 100 based on one or more parameters of the electrical signals delivered to coils 110 that induce the Lorentz forces maintaining the proof mass 104 in the null position.

Processing circuitry 102 may include one or more processors that are configured to implement functionality and/or process instructions for execution within accelerometer system 100. For example, processing circuitry 102 may be configured to process instructions stored in a memory. Processing circuitry 102 may include, for example, microprocessors, digital signal processors (DSPs), application specific integrated circuits (ASICs), field-programmable gate arrays (FPGAs), or equivalent discrete or integrated logic circuitry, or a combination of any of the foregoing devices or circuitry. Accordingly, processing circuitry 102 may include any suitable structure, whether in hardware, software, firmware, or any combination thereof, to perform the functions ascribed herein to processing circuitry 102.

A memory (not illustrated in FIG. 1) may be configured to store information within accelerometer system 100 during operation. The memory may include a computer-readable storage medium or computer-readable storage device. In some examples, the memory includes one or more of a short-term memory or a long-term memory. The memory may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, the memory stores program instructions for execution by processing circuitry 102.

Proof mass 104 may comprise an elongated member that extends from a first end of proof mass 104 to a second end of proof mass 104. In some examples, proof mass 104 forms a rectangular prism, but this is not required. Proof mass 104 may form any shape that extends from the first end of proof mass 104 to the second end of proof mass 104. Proof mass 104 may comprise one or more materials such as silicon, quartz, zirconate titanate, silicon carbide, aluminum, tungsten, or any combination thereof. In examples where proof mass 104 comprises quartz, the quartz material of proof mass 104 may provide thermal stability and ensure low noise levels in the acceleration measurement.

Magnet 105 is configured to generate a magnetic field that travels through a magnetic circuit. The magnetic field may be associated with a magnetic field strength. In some examples, magnet 105 comprises one or more materials such as Alnico, samarium-cobalt, neodymium-iron-boron, or any combination thereof. In some examples, magnet 105 receives forces and/or strains transmitted from excitation ring 108 caused by the construction of accelerometer system 100. In some examples, magnet 105 is part of a zero-gauge configuration of accelerometer system 100.

Magnet 105 may be associated with a minor loop slope. The minor loop slope may be associated with a hysteresis loop of a magnetic material of magnet 105. A hysteresis loop may indicate a relationship between magnetic field strength and a magnetization of the magnetic material. Minor loop slope is an important characteristic of the magnetic material because the minor loop slope helps describe how the magnetic material responds to changes in magnetic field and/or changes in current flowing through a coil (e.g., coils 110) with which the magnetic field interacts. A minor loop may represent the portion of a hysteresis loop where a magnetic field strength cycles back and forth around a point on the hysteresis loop. The minor loop slope may describe the change in induction of a magnet 105. The minor loop slope may indicate how a magnetization of the magnetic material responds to changes in the magnetic field strength. Magnetic materials comprising a higher minor loop slope may be more sensitive to magnetic field strength changes, while materials with a lower minor loop slope are less responsive to variations in the magnetic field strength.

As seen in FIG. 1, first pole piece 106A is connected to a first end of magnet 105 and second pole piece 106B is connected to a second end of magnet 105. Pole pieces 106 may comprise magnetic structures that focus a magnetic field generated by magnet 105 and drive a magnetic circuit corresponding to the magnetic field. For example, pole pieces 106 may cause the magnetic field generated by magnet 105 to turn a corner and flow through coils 110 to excitation ring 108. In some examples, pole pieces 106 include a permeable material such as invar, alloy 42, alloy 49, Mu Metal, Permalloy, or other such material.

In some examples, excitation ring 108 represents a non-moving member of accelerometer system 100. The term “non-moving member” may refer to a member representing a reference position by which a position of proof mass 104 may be compared. In some examples, magnet 105 and pole pieces 106 represent non-moving members of accelerometer system 100. In other words, the position of proof mass 104 may represent a position of proof mass 104 relative to magnet 105, a position of proof mass 104 relative to pole pieces 106, a position of proof mass 104 relative to excitation ring 108, or any combination thereof. In some examples, excitation ring 108 includes one or more dual metal materials (e.g., invar), which may be part of a magnetic circuit. In some examples, a magnetic circuit is referred to as a “magnetic flux loop.”

Coils 110 may conduct electricity such that electrical signals flow through coils 110. For example, a first electrical signal may flow through a path of coil 110A, and a second electrical signal may flow through a path of coil 110B. In some examples, the first electrical signal comprises a first current and the second electrical signal comprises a second current. Coil 110A may wrap around first pole piece 106A and an upper portion of magnet 105 in a first direction (e.g., clockwise or counterclockwise). Coil 110B may wrap around second pole piece 106B and a lower portion of magnet 105 in a second direction (e.g., clockwise or counterclockwise) opposite the first direction. That is, when coil 110A wraps around first pole piece 106A and the upper portion of magnet 105 in the clockwise direction, coil 110B wraps around second pole piece 106B and the lower portion of magnet 105 in the counterclockwise direction. When coil 110A wraps around first pole piece 106A and the upper portion of magnet 105 in the counterclockwise direction, coil 110B wraps around second pole piece 106B and the lower portion of magnet 105 in the clockwise direction.

Coil 110A may be physically connected to a first side of a proof mass assembly corresponding to proof mass 104 and coil 110B may be connected to a second side of a proof mass assembly corresponding to proof mass 104. This means that coil 110A may apply force to the first side of proof mass 104 and coil 110B may apply force to the second side of proof mass 104. Since coils 110 may be physically connected to proof mass 104 to form a single movable object, coils 110 and proof mass 104 may be referred to as a “proof mass assembly.” In some examples, sensors 112 are connected to proof mass 104 and/or coils 110 such that sensors 112 are part of the proof mass assembly. In some examples, an end of coil 110A are connected to an end of coil 110B near a center of the proof mass assembly (e.g., near a center of proof mass 104). This means that coil 110A and coil 110B may form a single electrical pathway, where coil 110A and coil 110B wrap around magnet 105 and pole pieces 106 in opposite directions.

In some examples, a cross section of magnet 105 is round (e.g., circular) and a cross section of each of pole pieces 106 is round (e.g., circular). This means that coils 110 may wrap around magnet 105 and pole pieces 106 in a round path. In some examples, coils 110 are wrapped around magnet 105 and pole pieces 106 tightly such that one or more turns of coils 110 touch one or more other turns, but this is not necessary. In some cases, one or more turns of coils 110 do not touch other turns. Since FIG. 1 represents a cutaway view of accelerometer system 100, the round path of coil 110A and the round path of coil 110B are not illustrated in FIG. 1. Coils 110 may extend fully around an outer surface of magnet 105 and pole pieces 206 such that the first electrical signal flows around the outer surface of magnet 105 and first pole piece 106A through coil 210A and the second electrical signal flows around the outer surface of magnet 105 and second pole piece 106B through coil 110B.

A magnetic circuit 120 may extend through magnet 105, pole pieces 106, coils 110, and excitation ring 108. For example, magnet 105 may generate a magnetic field such that magnetic flux travels through magnet 105 from second pole piece 106B to first pole piece. At first pole piece 106A, the magnetic flux may turn a corner and flow outwards from first pole piece 106A to excitation ring 108 across coil 110A. The magnetic flux may flow through excitation ring 108 to a lower portion of the accelerometer and flow outwards from excitation ring 108 to second pole piece 106B across coil 110B. At second pole piece 106B, the magnetic flux may turn a corner and return to magnet 105. This means that magnetic circuit 120 represents a magnetic flux loop where excitation ring 108 serves as a magnetic return path.

As described above, a first electrical current flows around first pole piece 106A according to a first current path of coil 110A and a second electrical current flows around second pole piece 106B according to a second current path of coil 110B. Since magnetic flux travels across the first current pathway of coil 110A according to magnetic circuit 120 and magnetic flux travels across the second current pathway of coil 110B direction according to magnetic circuit 120, the first electrical current flowing through coil 110A and the magnetic flux flowing across coil 110A may induce a first force and the second electrical current flowing through coil 110B and the magnetic flux flowing across coil 110B may induce a second force. The first force may represent a cross-product of the first electrical current flowing through coil 110A and the magnetic flux flowing across coil 110A, and the second force may represent a cross-product of the second electrical current flowing through coil 110B and the magnetic flux flowing across coil 110B.

In some examples, the first electrical current flowing through coil 110A flows along the first current pathway of coil 110A around first pole piece 106A in a first direction and the second electrical current flowing through coil 110B flows along the second current pathway of coil 110B around second pole piece 106B in a second direction opposite the first direction. Magnetic flux may flow across coil 110A in a first direction from first pole piece 106A to excitation ring 108 and magnetic flux may flow across coil 110B in a second direction from excitation ring 108 to second pole piece 106B. This means that the first force corresponding to the first electrical current flowing through coil 110A and the magnetic flux flowing across coil 110A and the second force corresponding to the second electrical current flowing through coil 110B and the magnetic flux flowing across coil 110B may act in the same direction relative to a longitudinal axis of magnet 105. For example, the first force and the second force may act in the same direction to collectively prevent a displacement of proof mass 104 from the null position.

Connector 122 may connect Proof mass 104 to excitation ring 108. In some examples, connector 122 is connected to a first end of proof mass 104, and a second end of proof mass 104 extends freely. This means that proof mass 104 may bend about connector 122. In some examples, a null position of proof mass 104 comprises a position of proof mass 104 relative to a first inner surface 124 of magnet 105 and a second inner surface 126 of magnet 105. For example, when proof mass 104 bends upward closer to first inner surface 124 and farther from second inner surface 126, proof mass 104 may displace in a first direction from the null position. When proof mass 104 bends downward away from first inner surface 124 and closer to second inner surface 126, proof mass 104 may displace in a second direction from the null position.

In some examples, first sensor 112A is configured to generate a first sense signal which indicates a width of a first gap 132 between proof mass 104 and first inner surface 124 and second sensor 112B is configured to generate a second sense signal which indicates a width of a second gap 134 between proof mass 104 and second inner surface 126. Consequently, the first sense signal and the second sense signal may indicate whether proof mass 104 is located in a null position. In some examples, first sensor 112A comprises a first capacitive plate that generates the first sense signal comprising a first capacitance signal. Second sensor 112B may comprise a second capacitive plate that generates the second sense signal comprising a second capacitance signal.

In some examples, a difference between the first capacitance signal generated by first sensor 112A and the second capacitance signal generated by second sensor 112B indicates an extent to which proof mass 104 is displaced from the null position. For example, a larger difference may represent a larger displacement of proof mass 104 and a smaller difference may represent a smaller displacement. In some examples, the first capacitance signal generated by first sensor 112A and the second capacitance signal generated by second sensor 112B indicate a direction of displacement of proof mass 104 from the null position. For example, the first capacitance signal and the second capacitance signal may indicate whether proof mass 104 is displaced upwards towards first inner surface 124 or is displaced downwards towards second inner surface 126.

Processing circuitry 102, in some examples, determines an acceleration of an object corresponding to accelerometer system 100 based on one or more electrical signals delivered to coils 110 to maintain proof mass 104 in the null position. For example, processing circuitry 102 may receive a signal corresponding to a capacitance of an interface between magnet 105 and proof mass 104. In some examples, the capacitance signal includes a first capacitance signal generated by first sensor 112A and a second capacitance signal generated by second sensor 112B. In some examples, the first capacitance signal generated by first sensor 112A indicates a width of a first gap 132 between proof mass 104 and the first inner surface 124 of magnet 105. In some examples, the second capacitance signal generated by the second sensor 112B indicates a width of a second gap 134 between proof mass 104 and the second inner surface of magnet 105.

Processing circuitry 102, in some examples, processes the first capacitance signal received from first sensor 112A and the second capacitance signal received from second sensor 112B in real time or near-real time. This means that processing circuitry 102 may monitor an extent to which proof mass 104 is displaced from the null position in real time or near-real time. As proof mass 104 moves relative to magnet 105, the first capacitance signal generated by first sensor 112A and the second capacitance signal generated by second sensor 112B may indicate the move in real time or near-real time. Processing circuitry 102 may operate in a closed-loop system where processing circuitry 102 receives the first capacitance signal and the second capacitance signal indicating the position of proof mass 104 and delivers electrical signals to coils 110 to maintain the proof mass 104 in the null position.

For example, processing circuitry 102 may determine, based on the first capacitance signal received from first sensor 112A and the second capacitance signal received from second sensor 112B, an extent to which proof mass 104 is displaced from the null position. Processing circuitry 102 may identify, based on the first capacitance signal and the second capacitance signal, one or more parameters for a first electrical signal delivered to coil 110A. Processing circuitry 102 may identify, based on the first capacitance signal and the second capacitance signal, one or more parameters for a second electrical signal delivered to coil 110B. In some examples, coil 110A is connected to coil 110B to form a single current pathway. In examples where coil 110A and coil 110B form a single current pathway, processing circuitry 102 may identify, based on the first capacitance signal and the second capacitance signal, one or more parameters for a single electrical signal for delivery to coils 110.

In some examples, processing circuitry 102 determines one or more parameters of a first electrical signal for delivery to coil 110A and determines one or more parameters of a second electrical signal for delivery to coil 110B to induce a first force corresponding to coil 110A and a second force corresponding to coil 110B. The first force and the second force may counteract a displacement of proof mass 104 caused by an acceleration of accelerometer system 100. For example, when accelerometer system 100 accelerates upwards along a longitudinal axis of magnet 105, this may cause proof mass 104 to bend downwards towards second inner surface 126. Processing circuitry 102 may determine that proof mass 104 is displacing from the null position towards second inner surface 126 based on the first capacitance signal generated by first sensor 112A and the second capacitance signal generated by second sensor 112B. Processing circuitry 102 may deliver one or more electrical signals to coils 110 to induce a first force corresponding to coil 110A and a second force corresponding to coil 110B, the first force and the second force counteracting the displacement of proof mass 104 towards second inner surface 126.

When accelerometer system 100 accelerates downwards along a longitudinal axis of magnet 105, this may cause proof mass 104 to bend upwards towards first inner surface 124. Processing circuitry 102 may determine that proof mass 104 is displacing from the null position towards first inner surface 124 based on the first capacitance signal generated by first sensor 112A and the second capacitance signal generated by second sensor 112B. Processing circuitry 102 may deliver one or more electrical signals to coils 110 to induce a first force corresponding to coil 110A and a second force corresponding to coil 110B, the first force and the second force counteracting the displacement of proof mass 104 towards first inner surface 124.

As described above, coil 110A may be wrapped around magnet 105 and a first pole piece 106A in a first direction (e.g., clockwise or counterclockwise), and coil 110B may be wrapped around magnet 105 and second pole piece 106B in a second direction (e.g., clockwise or counterclockwise) opposite the first direction so that the first force corresponding to coil 110A and the second force corresponding to coil 110B act in the same direction relative to the longitudinal axis of magnet 105. Coil 110A may be connected to coil 110B to form a single current pathway. Processing circuitry 102 may control a direction of current through the single pathway of coils 110B to control a direction of the first force corresponding to coil 110A and the second force corresponding to coil 110B. This means that when proof mass 104 displaces downwards towards second inner surface 126, processing circuitry 102 may cause the first force and the second force to act upwards towards the first inner surface 124. When proof mass 104 displaces upwards towards first inner surface 124, processing circuitry 102 may cause the first force and the second force to act downwards towards the second inner surface 126.

Magnet 105 may include a minor loop slope representing a relationship between magnetic field strength and magnetization. Since magnet 105 has one minor loop slope, the magnetic field strength and the magnetic flux across coil 110A may be the same as the magnetic field strength and the magnetic flux across coil 110B over time. In accelerometer systems that use two magnets with one magnet on either side of a proof mass, the two magnets may have slightly different minor loop slopes. This means that the magnetic field strength and the magnetic flux across coils on either side of the proof mass might not match, leading to an imbalance. Imbalances may cause inaccuracy in determined acceleration and/or introduce complexity required to account for imbalances. By including a single magnet (e.g., magnet 105) having a single minor loop slope, accelerometer system 100 may cause the magnetic field strength and magnetic flux across coil 110A to match the magnetic field strength and magnetic flux across coil 110B at all times, preventing imbalance across both sides of the accelerometer.

Vibration rectification represents a source of error in using an accelerometer to accurately perform navigation. Some accelerometer systems attempt to solve this issue by matching the minor loop slopes of two magnets on either side of a proof mass to cancel the effects of a scale factor under vibration conditions. Since accelerometer system 100 includes one magnetic circuit and, accelerometer system 100 may eliminate effects of mismatch in minor loop slope that occur in multi-magnet systems. Accelerometer system 100 includes a magnetic return path using a single magnet (e.g., magnet 105) with a pole piece of pole pieces 106 on each end of magnet 105. The magnetic flux travelling in the return path may come from one source (e.g., magnet 105). This means that accelerometer system 100 might eliminate magnet-to-magnet variation present in multi-magnet system.

Accelerometer system 100 may achieve torque rebalance of a quartz flexure accelerometer (e.g., maintaining proof mass 104 in the null position) by using a single magnet (e.g., magnet 105) and a symmetric return path (e.g., magnetic circuit 120 through excitation ring 108). A configuration of accelerometer system 100 may ensure increased flux symmetry and eliminate performance issues arising in systems that charge two magnets simultaneously to an equivalent energy product. Since two magnets often do not have identical minor loop slopes, charging two magnets at the same time may lead to imbalanced responses. Magnet 105 may have a single minor loop slope, thus ensuring that accelerometer system 100 avoids issues arising in multi-magnet systems. Accelerometer system 100 may improve vibration rectification error (VRE) and bias performance as compared with quartz flexure accelerometer systems that include more than one magnet.

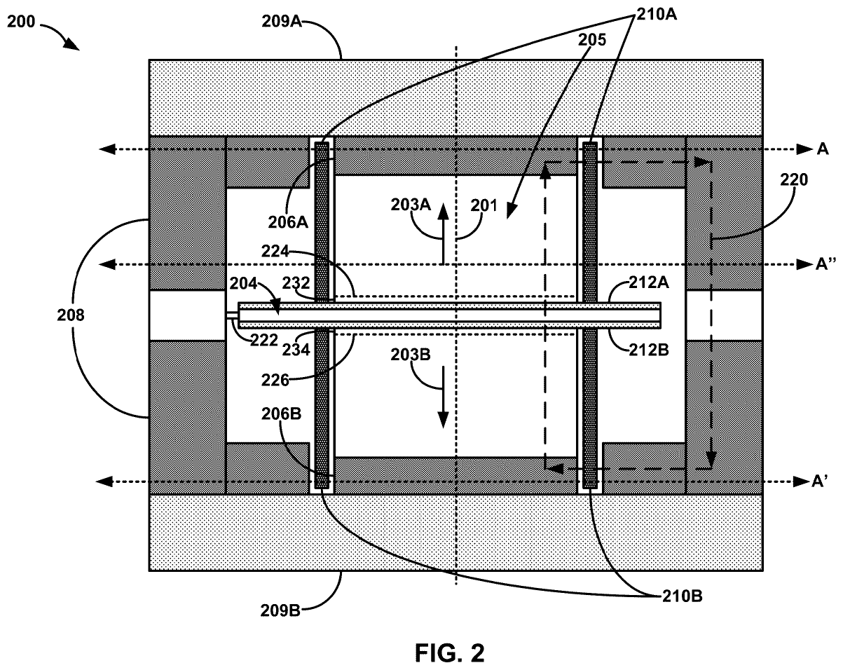

FIG. 2 is a conceptual diagram illustrating a side cutaway view of an accelerometer system 200, in accordance with one or more techniques of this disclosure. As seen in FIG. 2, accelerometer system 200 includes proof mass 204, magnet 205, first pole piece 206A and second pole piece 206B (collectively, “pole pieces 206”), excitation ring 208, first cap piece 209A and second cap piece 209B (collectively, “cap pieces 209”), coil 210A and coil 210B (collectively, “coils 210”), first sensor 212A and second sensor 212B (collectively, “sensors 212”), and connector 222. Accelerometer system 200 may be an example of accelerometer system 100 of FIG. 1. Proof mass 204 may be an example of proof mass 104 of FIG. 1. Magnet 205 may be an example of magnet 105 of FIG. 1. Pole pieces 206 may be examples of pole pieces 106 of FIG. 1. Excitation ring 208 may be an example of excitation ring 108 of FIG. 1. Coils 210 may be examples of coils 110 of FIG. 1. Sensors 212 may be examples of sensors 112 of FIG. 1.

Accelerometer system 200 may be configured to sense an acceleration along sense axis 201. For example, accelerometer system 200 may be configured to sense an acceleration along sense axis 201 in a first direction 203A and accelerometer system 200 may be configured to sense an acceleration along sense axis 201 in a second direction 203B. In some cases, accelerometer system 200 precisely determines a magnitude and a direction of the acceleration along the sense axis 201 in real time or near-real time such that processing circuitry (not illustrated in FIG. 2) may track a position of accelerometer system 200 using dead reckoning. For example, an integral of acceleration is velocity and an integral of velocity is position. This means that when an initial position of accelerometer system 200 is known and acceleration is tracked in real time, accelerometer system 200 may be configured to track the position of accelerometer system 200 in real time.

Proof mass 204 comprises a mass used to detect and measure acceleration. Accelerometers may sense acceleration, the rate of change of velocity. In accelerometer system 200, proof mass 204 may move in response to changes in acceleration. When accelerometer system 200 experiences acceleration along sense axis 201, proof mass 204 may experience a force opposite a direction of the acceleration. For example, when accelerometer system 200 accelerates in the first direction 203A along sense axis 201, this may apply a force to proof mass 204 in second direction 203B that is equal and opposite the acceleration. When accelerometer system 200 accelerates in the second direction 203B along sense axis 201, this may apply a force to proof mass 204 in first direction 203A that is equal and opposite the acceleration.

Proof mass 204 may comprise an elongated member that extends from a first end of proof mass 204 to a second end of proof mass 204. The first end of proof mass 204 may be connected to excitation ring 208 by connector 222. The second end of proof mass 204 may extend freely without being connected to excitation ring 208. This means that proof mass 204 may bend about connector 222. In some examples, proof mass 204 forms a rectangular prism, but this is not required. Proof mass 204 may form any shape that extends from the first end of proof mass 204 to the second end of proof mass 204. Proof mass 204 may comprise one or more materials such as silicon, quartz, zirconate titanate, silicon carbide, aluminum, tungsten, or any combination thereof. In examples where proof mass 204 comprises quartz, the quartz material of proof mass 204 may provide thermal stability and ensure low noise levels in the acceleration measurement.

Magnet 205 may be configured to generate a magnetic field that travels through a magnetic circuit. The magnetic field may be associated with a magnetic field strength and/or a magnetic flux. Magnet 205 may generate a magnetic field due to the alignment and motion of atomic or molecular dipoles. In most materials, individual atoms or molecules may behave like magnets due to the motion of their electrons. These electron movements may create magnetic moments or dipole moments. Electrons may have an intrinsic property called “spin,” which behaves like a magnetic dipole. Electrons also move in orbits around a nucleus, creating a magnetic moment due to orbital motion. In a magnetic material, many atomic dipoles are aligned. When these magnetic moments are aligned, individual magnetic fields add up to create a macroscopic magnetic field, which extends beyond the magnetic material itself. A magnetic field corresponding to magnet 205 may be visualized as lines that extend outward from magnet 205, forming closed loops.

Magnet 205 may include one or more magnetic materials configured to generate a magnetic field beyond magnet 205. In some examples, magnet 205 comprises one or more materials such as Alnico, samarium-cobalt, neodymium-iron-boron, or any combination thereof. In some examples, magnet 205 receives forces and/or strains transmitted from excitation ring 208 caused by the construction of accelerometer system 200. In some examples, magnet 205 is part of a zero-gauge configuration of accelerometer system 200.

In some examples, magnet 205 forms a cylindrical shape extending along sense axis 201 from a first end of magnet 205 to a second end of magnet 205. Magnet 205 may form an open channel through a center of magnet 205 perpendicular to sense axis 201. Proof mass 204 may extend through the open channel formed by magnet 205 perpendicular to the sense axis 201. Magnetic material of magnet 205 may surround a portion of proof mass 204 that extends through the open channel of magnet 205. This means that a magnetic flux may flow through magnet 205 along a magnetic circuit and around proof mass 204.

As seen in FIG. 2, a first end of first pole piece 206A may be connected to first cap piece 209A and a second end of first pole piece 206A may be connected to a first end of magnet 205. A first end of second pole piece 206B may be connected to a second end of magnet 205 and a second end of second pole piece 206B may be connected to second cap piece 209B. Pole pieces 206 may comprise magnetic structures that enable a magnetic field generated by magnet 105 to be focused and drive a magnetic circuit corresponding to the magnetic field. For example, pole pieces 206 may cause the magnetic field generated by magnet 205 to turn a corner and flow through coils 210 to excitation ring 208. In some examples, pole pieces 206 include a permeable material such as invar, alloy 42, alloy 49, Mu Metal, Permalloy, or other such material.

Excitation ring 208 may represent a magnetic return path for a magnetic flux generated by magnet 205. Excitation ring 208, in some examples, represents a tube-shaped member extending form a first end of excitation ring 208 to a second end of excitation ring 208 along sense axis 201. The first end of excitation ring 208 may be connected to first cap piece 209A and the second end of excitation ring 208 may be connected to second cap piece 209B. Magnetic flux output from magnet 205 may return to magnet 205 via excitation ring 208. In some examples, a cross section of excitation ring 208 is round. Magnet 205 and pole pieces 206 may extend through a center of excitation ring 208 along sense axis 201. In some examples, excitation ring 208 includes one or more dual metal materials (e.g., invar), which may be part of a magnetic circuit. In some examples, a magnetic circuit is referred to as a “magnetic flux loop.”

Cap pieces 209, in some examples, represent cap pieces of accelerometer system 200 that form a housing of accelerometer system 200. In some examples, cap pieces 209 include quartz, but this is not necessary. Cap pieces 209 may comprise one or more materials other than quartz. In some examples, magnetic flux generated by magnet 205 travels through pole pieces 206, coils 210, and excitation ring 208 without traveling though cap pieces 209.

Coils 210 may, in some cases, conduct electricity such that electrical signals flow through coils 210. For example, a first electrical signal may flow through a first current path of coil 210A, and a second electrical signal may flow through a second current path of coil 210B. In some examples, the first electrical signal comprises a first current and the second electrical signal comprises a second current. In some examples, coil 210A and coil 210B are connected to form a single current pathway. For example, an end of coil 210A may be connected to an end of coil 210B near a center of accelerometer system 200 proximate to proof mass 204. In examples where coils 210 form a single current pathway, the first electrical signal may be the same as the second electrical signal.

Coil 210A may wrap around first pole piece 206A and an upper portion of magnet 205 in a first direction (e.g., clockwise or counterclockwise). Coil 210B may wrap around second pole piece 206B and a lower portion of magnet 205 in a second direction (e.g., clockwise or counterclockwise) opposite the first direction. That is, when coil 210A wraps around first pole piece 206A and the upper portion of magnet 205 in the clockwise direction, coil 210B wraps around second pole piece 206B and the lower portion of magnet 205 in the counterclockwise direction. When coil 210A wraps around first pole piece 206A and the upper portion of magnet 205 in the counterclockwise direction, coil 210B wraps around second pole piece 206B and the lower portion of magnet 205 in the clockwise direction.

First sensor 212A may represent a first capacitive plate configured to generate a first capacitance signal, and second sensor 212B may represent a second capacitive plate configured to generate a second capacitance signal. In some examples, the first capacitance signal indicates a width of first gap 232 and the second capacitance signal indicates a width of second gap 234. This means that the first capacitance signal and the second capacitance signal may indicate an extent to which proof mass 104 is displaced from a null position relative to magnet 205.

In some examples, a proof mass assembly includes proof mass 204, sensors 212, and coils 210. Proof mass 204, sensors 212, and coils 210 may be referred to as a “proof mass assembly” because proof mass 204, sensors 212, and coils 210 may be connected together such that proof mass 204, sensors 212, and coils 210 move together. The proof mass assembly may be suspended such that proof mass 204 and sensors 212 extend through magnet 205 and coils 210 wrap around magnet 205 and pole pieces 206. For example, magnet 205 may form a gap, where a cross-section of the gap is sized such that proof mass 204 and sensors 212 fit through the gap. In some examples, a first gap 232 exists between the proof mass assembly and a first inner surface 224 of magnet 205 and a second gap 234 exists between the proof mass assembly and a second inner surface of magnet 205. This means that a portion of the proof mass assembly may extend through a center of magnet 205 and a portion of the proof mass assembly may wrap around an outside of magnet 205 without the proof mass assembly being physically connected to magnet 205.

In some examples, the proof mass 204 and the proof mass assembly occupy a null position relative to magnet 205. The null position may represent a position of proof mass 204 relative to first inner surface 224 and second inner surface 226 of magnet 205. Proof mass 204 may displace from the null position by bending upwards towards first inner surface 224 such that the first gap 232 between the proof mass assembly and first inner surface 224 decreases and the second gap 234 between the proof mass assembly and second inner surface 226 increases. Additionally, or alternatively, proof mass 204 may displace from the null position by bending downwards towards second inner surface 226 such that the second gap 234 between the proof mass assembly and second inner surface 226 decreases and the first gap 232 between the proof mass assembly and first inner surface 224 increases.

In some examples, a width of first gap 232 when proof mass 204 is in the null position is referred to as a “null width” of first gap 232 and a width of second gap 234 when proof mass 204 is in the null position is referred to as a “null width” of second gap 234. In some examples, the null width of first gap 232 is within a range from 0.0005 inches to 0.0025 inches. In some examples, s null width of second gap 234 is within a range from 0.0005 inches to 0.0025 inches. When the width of first gap 232 is at the null width of first gap 232 and the width of second gap 234 is at the null width of second gap 234, proof mass 204 may be located at a null position.

In some examples, first gap 232 includes a first capacitance value. Processing circuitry of accelerometer system 200 may detect the first capacitance value of first gap 232, which in a closed-loop differential capacitance configuration can be detected and used by the processing circuitry to determine the acceleration of accelerometer system 200. Additionally, second gap 234 may have a second capacitance value. The processing circuitry may detect the second capacitance value of second gap 234, which in a closed-loop differential capacitance configuration can be detected and used by the processing circuitry to determine the acceleration of accelerometer system 200. In some examples, an increase in a width of first gap 232 and a decrease in a width of second gap 234 indicates an acceleration of accelerometer system 200 in first direction 203A. Conversely, an increase in the width of second gap 234 and a decrease in the width of first gap 232 may be indicative of an acceleration of accelerometer system 200 in the second direction 203B.

The processing circuitry of accelerometer system 200 may deliver a first electrical signal to coil 210A and deliver a second electrical signal to coil 210B in order to counter-balance a displacement of proof mass 204 from the null position. The magnitude of the first electrical signal and the magnitude of the second electrical signal for maintaining the proof mass 204 in the null position may be correlated with the magnitude of the acceleration along sense axis 201. For example, the processing circuitry of accelerometer system 200 may be configured to deliver a first electrical signal and a second electrical signal to coils 210 in order to position proof mass 204 at the null position. In some examples, when accelerometer system 200 accelerates along sense axis 201, the processing circuitry increases an electrical current magnitude of the first electrical signal delivered to coil 210A and increases an electrical current magnitude of the second electrical signal delivered to coil 210B to maintain the proof mass 204 at the null position. In this example, the electrical current magnitude of the first electrical signal and the electrical current magnitude of the second electrical signal are proportional to the magnitude of the acceleration along the sense axis 201.

Preventing proof mass 204 from displacing from the null position may be referred to herein as the “servo effect.” In some examples, the processing circuitry causes one or more Lorentz forces to counterbalance an acceleration force applied to proof mass 204 such that proof mass 204 does not move from the null position. This means that the processing circuitry is configured to adjust the one or more Lorentz forces in real time or near-real time such that the one or more Lorentz forces counterbalance the acceleration force applied to proof mass 204 at any given time, thus constantly maintaining the proof mass 204 at the null position. The electrical signals required to induce the one or more Lorentz forces for keeping the proof mass 204 in the null position may be generated by the processing circuitry based on the first capacitance signal received from first sensor 212A and the second capacitance signal received from the second sensor 212B.

As seen in FIG. 2, magnetic circuit 220 extends through accelerometer system 200. Magnetic circuit 220 may represent a pathway of magnetic flux generated by magnet 205. For example, magnetic flux may travel through magnet 205 from a second end of magnet 205 to a first end of magnet 205. The magnetic flux may turn a corner at first pole piece 206A connected to the first end of magnet 205 and travel from first pole piece 206A to excitation ring 208 across coil 210A. The magnetic flux may travel through excitation ring 208 and travel from excitation ring 208 to second pole piece 206B across coil 210B. The magnetic flux may turn a corner and complete magnetic circuit 220 by returning to magnet 205.

A cross-product of the magnetic flux travelling across coil 110A with the first current travelling though coil 110A may represent a first Lorentz force, and a cross-product of the magnetic flux travelling across coil 110B with the second current travelling though coil 110B may represent a second Lorentz force. In some examples, the first Lorentz force and the second Lorentz force act in the same direction along sense axis 201. For example, the first Lorentz force and the second Lorentz force may both act in the first direction 203A or the first Lorentz force and the second Lorentz force may both act in the second direction 203B. The first Lorentz force and the second Lorentz force may counter an acceleration force applied to proof mass 204 due to an acceleration of accelerometer system 200. When a sum of the first Lorentz force and the second Lorentz force is equal and opposite the acceleration force applied to proof mass 204, the proof mass 204 may remain in the null position.

Since the magnitude of the current applied to coils 210 determines the magnitude of the first Lorentz force and the second Lorentz force, the magnitude of the current applied to coils 210 for maintaining proof mass 204 in the null position may be correlated with an acceleration of accelerometer system 200. This means that processing circuitry of the accelerometer system 200 may determine the acceleration of accelerometer system 200 based on the magnitude of the current applied to coils 210. In some examples, coil 210A is connected to coil 210B such that coils 210 form a single current pathway. This means that the magnitude of the current flowing through coil 210A may be the same as the magnitude of the current flowing though coil 210B.

Magnet 205 may be associated with a single uniform minor loop slope throughout a magnetic material of magnet 205. This means that the entirety of magnet 205 may exhibit the same relationship between magnetic field strength and magnetization. Since all portions of magnet 205 may include the same minor loop slope, this may ensure that a magnetic flux and/or a magnetic field strength across coil 210A is the same as a magnetic flux and/or a magnetic field strength across coil 210B at any given time. This is because any change in a magnetic field strength of a magnetic field output by magnet 205 may be realized in the same way at coil 210A and coil 210B. This means that accelerometer system 200 including a single magnet (e.g., magnet 205) may eliminate imbalances that occur in accelerometer systems that use more than one magnet.

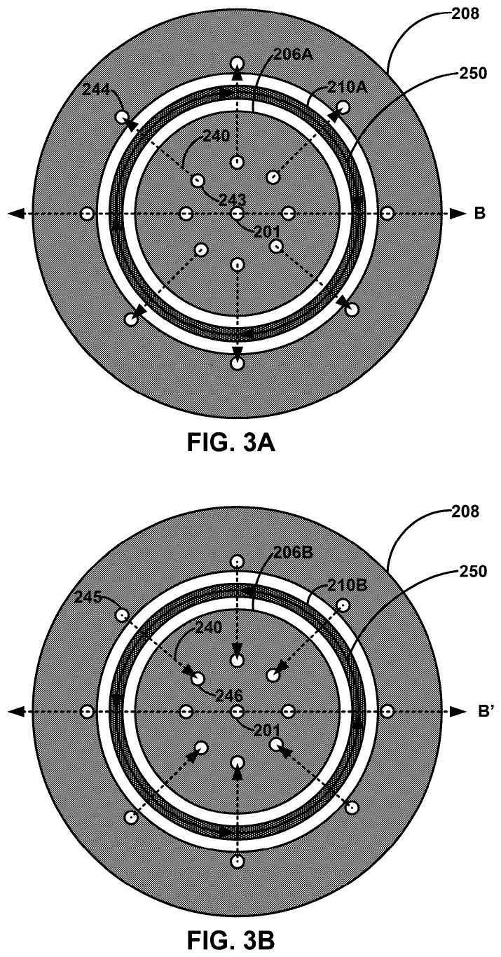

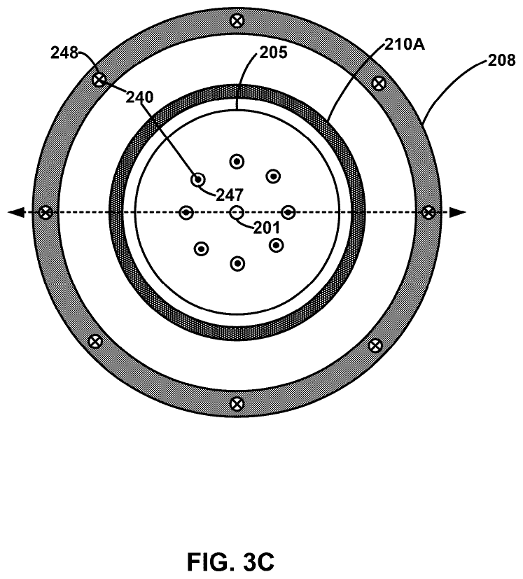

FIG. 3A is a conceptual diagram illustrating a first horizontal cutaway view of the accelerometer system 200 of FIG. 2, in accordance with one or more techniques of this disclosure. The first horizontal cutaway view shown in FIG. 3A may represent a cross section of the accelerometer system 200 of FIG. 2 along the cutaway line A shown in the side cutaway view of accelerometer system 200 of FIG. 2. In other words, the first horizontal cutaway view illustrated in FIG. 3A may represent the parts of the accelerometer system 200 that extend into the page of FIG. 2 from cutaway line A and extend out of the page of FIG. 2 from cutaway line A. As seen in FIG. 3A, the horizontal cross-section of the accelerometer system is round in shape, whereas the vertical cross-section of the accelerometer system shown in FIG. 2 is rectangular in shape. The vertical cutaway view shown in FIG. 2 may represent a cross-section of the system along the cutaway line B illustrated in FIG. 3A.

The first horizontal cutaway view illustrated in FIG. 3A may include first pole piece 206A, coil 210A, and excitation ring 208. First pole piece 206A fits within a center of coil 210A. Coil 210A fits within a gap between first pole piece 206A and excitation ring 208. This means that magnetic flux may flow outwards from the outer circumference of first pole piece 206A through the coil 210A to the inner circumference of excitation ring 208. Excitation ring 208 may, in some cases, extend fully around the outer circumference of coil 210A and first pole piece 206A. By extending fully around the outer circumference of coil 210A and first pole piece 206A, excitation ring 208 may secure the coil 210A and first pole piece 206A such that a space within excitation ring 208 is protected from one or more harmful environments. In some examples, excitation ring 208 is part of a housing of the accelerometer system.

Magnetic flux 240 and electrical current 250 may flow through the first horizontal cutaway view of the accelerometer system 200 of FIG. 2. As seen in FIG. 3A, magnetic flux 240 flows through first pole piece 206A such that magnetic flux 240 enters the plane of FIG. 3A from below the plane of FIG. 3A at point 243. The magnetic flux 240 may travel from point 243 through first pole piece 206A to an outer circumference of first pole piece 206A. Magnetic flux 240 may travel from the outer circumference of first pole piece 206A to an inner circumference of excitation ring 208 across coil 210A. When the magnetic flux 240 travels across coil 210A to point 244 within excitation ring 208, the magnetic flux 240 may travel outside of the plane of FIG. 3A from point 244. In some examples, the magnetic flux 240 travels downwards from the plane of FIG. 3A from point 244 through cover excitation ring 208.

Magnetic flux 240 may flow outward from first pole piece 206A at any point along the outer circumference of first pole piece 206A. In some examples, magnetic flux 240 travels substantially perpendicular to a tangent line at any point along the outer circumference of first pole piece 206A. This means that magnetic flux 240 may radiate outwards from first pole piece 206A from the outer circumference of first pole piece 206A. Point 243 and point 244 are not the only possible entry and exit points. Magnetic flux may enter the plane of FIG. 3A from any point on first pole piece 206A and exit the plane of FIG. 3A from any point on excitation ring 208.

An electrical current 250 may flow through coil 210A. Magnetic flux may travel across coil 210A perpendicular to the electrical current 250 flowing through the coil 210A. The interaction between the magnetic flux 240 and the electrical current 250 at coil 210A may create a first Lorentz force which counteracts an acceleration of the accelerometer system 200 of FIG. 2. In some examples, a magnitude of the first Lorentz force is a cross-product of a magnitude of the magnetic flux 240 with a magnitude of the electrical current 250. In some examples, processing circuitry of accelerometer system 200 controls a magnitude and/or a direction of the electrical current 250 such that the first Lorentz force maintains a proof mass (e.g., proof mass 204 of FIG. 2) in a null position. Acceleration of the accelerometer system 200 may apply an acceleration force to the proof mass 204 such that the proof mass 204 displaces from the null position unless processing circuitry of accelerometer system 200 induces equal and opposite Lorentz forces applied to proof mass 204. The processing circuitry of accelerometer system 200 may control the magnitude of the electrical current 250 such that, at any given time, one or more Lorentz forces are equal and opposite the acceleration force applied to proof mass 204.

In some examples, the first Lorentz force corresponding to the interaction between magnetic flux 240 and electrical current 250 at coil 210A extends in a first direction along sense axis 201. In the first horizontal cutaway view of FIG. 3A, sense axis 201 extends perpendicular to the page of FIG. 3A. This means that the first Lorentz force may extend into the page of FIG. 3A or extend outwards from the page of FIG. 3A. In some examples, magnetic flux 240 continuously extends outwards from first pole piece 206A to excitation ring 208 across coil 210A. In other words, a direction of magnetic flux 240 may remain the same over time. The processing circuitry of accelerometer system 200 may control the direction and a magnitude of the electrical current 250 in order to control the direction and magnitude of the first Lorentz force.

As seen in FIG. 3A, electrical current 250 travels clockwise through coil 210A. When electrical current 250 travels clockwise through coil 210A, this may cause the first Lorentz force corresponding to interaction between magnetic flux 240 and electrical current 250 at coil 210A to extend in a first direction along sense axis 201. Electrical current 250 is not limited to travelling clockwise through coil 210A. In some examples, electrical current 250 travels counterclockwise through coil 210B. When electrical current 250 travels counterclockwise through coil 210A, this may cause the first Lorentz force corresponding to interaction between magnetic flux 240 and electrical current 250 at coil 210A to extend in a second direction along sense axis 201 opposite the first direction.

FIG. 3B is a conceptual diagram illustrating a second horizontal cutaway view of the accelerometer system 200 of FIG. 2, in accordance with one or more techniques of this disclosure. The second horizontal cutaway view shown in FIG. 3B may represent a cross section of the accelerometer system 200 of FIG. 2 along the cutaway line A′ shown in the side cutaway view of accelerometer system 200 of FIG. 2. In other words, the second horizontal cutaway view illustrated in FIG. 3B may represent the parts of the accelerometer system 200 that extend into the page of FIG. 2 from cutaway line A′ and extend out of the page of FIG. 2 from cutaway line A′. The vertical cutaway view shown in FIG. 2 may represent a cross-section of the system along the cutaway line B′ illustrated in FIG. 3B.

The second horizontal cutaway view illustrated in FIG. 3B may include second pole piece 206B, coil 210B, and excitation ring 208. Second pole piece 206B fits within a center of coil 210A. Coil 210B fits within a gap between second pole piece 206B and excitation ring 208. This means that magnetic flux may flow inwards from the inner circumference of excitation ring 208 through the coil 210B to the outer circumference of second pole piece 206B. Excitation ring 208 may, in some cases, extend fully around the outer circumference of coil 210B and second pole piece 206B. By extending fully around the outer circumference of coil 210B and second pole piece 206B, excitation ring 208 may secure the coil 210B and second pole piece 206B such that a space within excitation ring 208 is protected from one or more harmful environments. In some examples, excitation ring 208 is part of a housing of the accelerometer system.

Magnetic flux 240 and electrical current 250 may flow through the second horizontal cutaway view of the accelerometer system 200 of FIG. 2. As seen in FIG. 3B, magnetic flux 240 flows through excitation ring 208 such that magnetic flux 240 enters the plane of FIG. 3B from above the plane of FIG. 3B at point 245. The magnetic flux 240 may travel from point 245 through excitation ring 208 to an inner circumference of excitation ring 208. Magnetic flux 240 may travel from the inner circumference of excitation ring 208 to an outer circumference of second pole piece 206B across coil 210B. The magnetic flux 240 may travel through second pole piece 206B to point 246. When the magnetic flux 240 travels across coil 210B to point 246 within second pole piece 206B, the magnetic flux 240 may travel outside of the plane of FIG. 3B from point 246. In some examples, the magnetic flux 240 travels upwards from the plane of FIG. 3B from point 246 through second pole piece 206B.

An electrical current 250 may flow through coil 210B. In some examples where coil 210A and coil 210B are connected to form a single current path, the electrical current 250 flowing through coil 210A is the same as the electrical current flowing through coil 210B. But in some cases, coil 210A may be wrapped in a first direction (e.g., clockwise or counterclockwise) around magnet 205 and first pole piece 206A and coil 210B may be wrapped in a second direction (e.g., clockwise or counterclockwise) opposite the first direction around magnet 205 and second pole piece 206B. This means that even when electrical current 250 flowing through coil 210A as illustrated in FIG. 3A and electrical current 250 flowing through coil 210B as illustrated in FIG. 3B represent the same current, a direction of electrical current 250 flowing through coil 210A may be opposite a direction of current flowing through coil 210B.

Magnetic flux may travel across coil 210B perpendicular to the electrical current 250 flowing through the coil 210B. An interaction between the magnetic flux 240 and the electrical current 250 at coil 210B may create a second Lorentz force which counteracts an acceleration of the accelerometer system 200 of FIG. 2. In some examples, a magnitude of the second Lorentz force is a cross-product of a magnitude of the magnetic flux 240 with a magnitude of the electrical current 250. In some examples, processing circuitry of accelerometer system 200 controls a magnitude and/or a direction of the electrical current 250 such that the second Lorentz force maintains a proof mass (e.g., proof mass 204 of FIG. 2) in a null position. Acceleration of the accelerometer system 200 may apply an acceleration force to the proof mass 204 such that the proof mass 204 displaces from the null position unless processing circuitry of accelerometer system 200 induces equal and opposite Lorentz forces applied to proof mass 204. The processing circuitry of accelerometer system 200 may control the magnitude and a direction of the electrical current 250 such that, at any given time, one or more Lorentz forces are equal and opposite the acceleration force applied to proof mass 204.

In some examples, the second Lorentz force corresponding to the interaction between magnetic flux 240 and electrical current 250 at coil 210B extends in a first direction along sense axis 201. In the first horizontal cutaway view of FIG. 3B, sense axis 201 extends perpendicular to the page of FIG. 3B. This means that the second Lorentz force may extend into the page of FIG. 3B or extend outwards from the page of FIG. 3B. In some examples, magnetic flux 240 continuously extends inwards from excitation ring 208 to second pole piece 206B across coil 210B. In other words, a direction of magnetic flux 240 across coil 210B may remain the same over time. The processing circuitry of accelerometer system 200 may control the direction and a magnitude of the electrical current 250 in order to control the direction and magnitude of the second Lorentz force.

As seen in FIG. 3B, electrical current 250 travels counterclockwise through coil 210B. When electrical current 250 travels counterclockwise through coil 210B, this may cause the second Lorentz force corresponding to interaction between magnetic flux 240 and electrical current 250 at coil 210B to extend in a first direction along sense axis 201. Electrical current 250 is not limited to travelling counterclockwise through coil 210B. In some examples, electrical current 250 travels counterclockwise through coil 210B. When electrical current 250 travels counterclockwise through coil 210B, this may cause the second Lorentz force corresponding to interaction between magnetic flux 240 and electrical current 250 at coil 210B to extend in a second direction along sense axis 201 opposite the first direction.

In some examples, the first Lorentz force induced by the interaction between magnetic flux 240 and electrical current 250 at coil 210A and the second Lorentz force induced by the interaction between magnetic flux 240 and electrical current 250 at coil 210A act in the same direction along sense axis 201. This is because magnetic flux 240 consistently crosses coil 210A in a first direction from first pole piece 201A to excitation ring 208 magnetic flux 240 consistently crosses coil 210A in a second direction from excitation ring 208 to second pole piece 206B, the second direction opposite the first direction. Since the magnetic flux 240 crosses coil 210A in a direction opposite the direction magnetic flux 240 crosses coil 210A, it may be beneficial for electrical current 250 travel through coil 210A in a direction opposite a direction electrical current travels through coil 210B. Since an acceleration force acts on proof mass 204 when accelerometer system 200 accelerates along sense axis 201, it may be beneficial for the first Lorentz force and the second Lorentz force to act in the same direction opposite the acceleration force.

Since accelerometer system 200 includes a single magnet (e.g., magnet 205) between first pole piece 206A and second pole piece 206B, a magnitude of magnetic flux 240 across coil 210A may be the same as a magnitude of magnetic flux 240B across coil 210B at any given time. In some examples, a magnetic field strength at coil 210A is the same as a magnetic field strength at coil 210B. This is because magnet 205 includes a single minor loop slope. Since magnet 205 includes a single minor loop slope, changes in magnetic field strength may affect magnetic flux 240 across coil 210A and magnetic flux 240 across coil 210B in the same way so there is not a difference between magnetic flux 240 across coil 210A and magnetic flux 240 across coil 210B. This means that accelerometer system 200 may avoid imbalances present in systems that include a separate magnet on either side of a proof mass.

FIG. 3C is a conceptual diagram illustrating a third horizontal cutaway view of the accelerometer system 200 of FIG. 2, in accordance with one or more techniques of this disclosure. The third horizontal cutaway view shown in FIG. 3C may represent a cross section of the accelerometer system 200 of FIG. 2 along the cutaway line A″ shown in the side cutaway view shown in FIG. 2. In other words, the third horizontal cutaway view may represent the parts of the system that extend into the page of FIG. 2 from cutaway line A″ and extend out of the page of FIG. 2 from cutaway line A″. As seen in FIG. 3C, magnet 205 is located in a center of coil 210A. In some examples, coil 210A wraps around an outer circumference of magnet 205. Coil 210A may be located in a space between excitation ring 208 and magnet 205.

Magnet 205 may generate a magnetic flux 240 that travels through a magnetic circuit. For example, magnetic flux 240 may travel through magnet 205 from a second end of magnet 205 to a first end of magnet 205. This means that in the third horizontal cutaway view of the accelerometer system 200 of FIG. 2, magnetic flux 240 may travel out of the page of FIG. 3C (e.g., out of the page of FIG. 3C through point 247). For example, magnetic flux 240 may travel through magnet 205 out of the page of FIG. 3C, travel through first pole piece 206A, and travel from first pole piece 206A to excitation ring 208 across coil 210A at a location above the plane of FIG. 3C. The magnetic flux may travel through excitation ring from a position above the plane of FIG. 3C to a position below the plane of FIG. 3C. This means that magnetic flux 240 may travel through excitation ring 208 into the page of FIG. 3C (e.g., into the page of FIG. 3C at point 248).

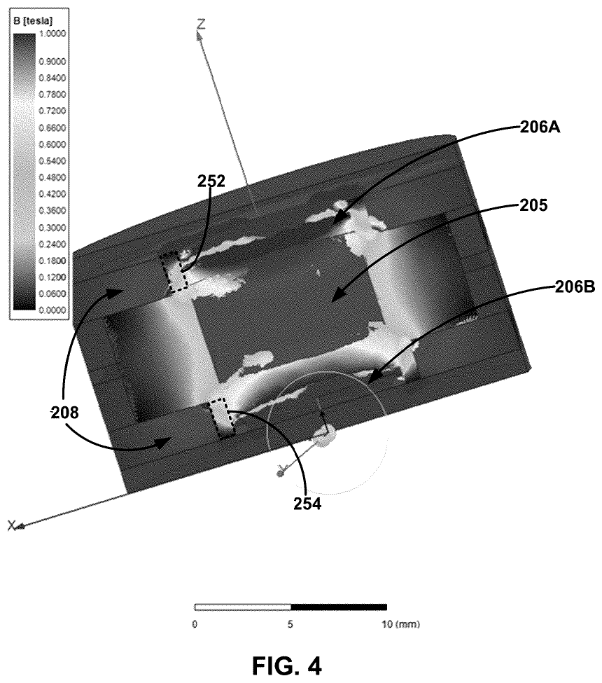

FIG. 4 is a conceptual diagram illustrating a magnetic field strength throughout a cross-section of the accelerometer system 200 of FIG. 2, in accordance with one or more techniques of this disclosure. As seen in FIG. 4, accelerometer system 200 includes a magnet 205, a first pole piece 206A, a second pole piece 206B, and an excitation ring 208. Magnet 205 may generate magnetic flux such that a magnetic field strength at gap 252 between first pole piece 206A and excitation ring 208 is the same as a magnetic field strength at gap 254 between second pole piece 206B and excitation ring 208. In other words, since accelerometer system 200 includes a single magnet (e.g., magnet 205), there may not be an imbalance between the magnetic field at gap 252 and gap 254.

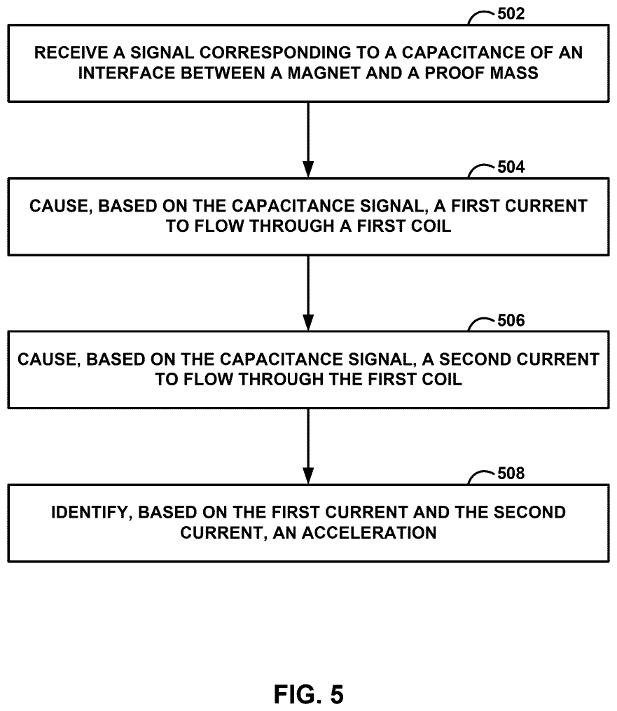

FIG. 5 is a flow diagram illustrating an example operation for determining an acceleration using an accelerometer including a single magnet, in accordance with one or more techniques of this disclosure. FIG. 5 is described with respect to accelerometer system 100, of FIG. 1. However, the techniques of FIG. 5 may be performed by different components of accelerometer system 100 or by additional or alternative devices.

Processing circuitry 102 may receive a signal corresponding to a capacitance of an interface between magnet 105 and proof mass 104 (502). In some examples, to receive the capacitance signal, processing circuitry 102 is configured to receive a first capacitance signal component corresponding to a first gap between magnet 105 and proof mass 104 and receive a second capacitance signal corresponding to a second gap between magnet 105 and proof mass 104. The first gap may be located on a first side of proof mass 104 and the second gap may be located on a second side of proof mass 104. In some examples, proof mass 104 passes through a center of magnet 105.

Processing circuitry 102 may cause, based on the capacitance signal, a first current to flow through coil 110A (504). Processing circuitry 102 may cause, based on the capacitance signal, a second current to flow through coil 110B (506). A first Lorentz force may correspond to the magnetic flux and the first current. A second Lorentz force may correspond to the magnetic flux and the second current. The first Lorentz force and the second Lorentz force may maintain proof mass 104 in a null position. For example, an acceleration of accelerometer system 100 may apply an acceleration force to proof mass 104. The first Lorentz force and the second Lorentz force may counteract the acceleration force to maintain the proof mass 104 in the null position. Processing circuitry 102 may identify, based on the first current and the second current, an acceleration of accelerometer system 100 (508).

The following numbered clauses may demonstrate one or more aspects of the disclosure.
Clause 1: An accelerometer system includes a magnet having a first end and a second end opposite the first end, wherein the magnet is configured to generate a magnetic flux that flows through the magnet from the second end of the magnet to the first end of the magnet, a proof mass extending through the magnet, a first coil disposed around a first portion of the magnet, and a second coil disposed around a second portion of the magnet. The accelerometer system also includes processing circuitry configured to: receive a signal corresponding to a capacitance of an interface between the magnet and the proof mass; cause, based on the signal, a first current to flow through the first coil; and cause, based on the signal, a second current to flow through the second coil. A first force corresponding to the magnetic flux and the first current and a second force corresponding to the magnetic flux and the second current may maintain the proof mass in a null position.
Clause 2: The accelerometer system of clause 1, wherein the magnet has a minor loop slope representing a relationship between a magnetic field strength of the magnet and a magnetization of the magnet, and wherein the minor loop slope of the magnet is the same at the first portion of the magnet and the second portion of the magnet.
Clause 3: The accelerometer system of any of clauses 1-2, wherein the first current flows through the first coil in a first direction, and wherein the second current flows through the second coil in a second direction opposite the first direction.
Clause 4: The accelerometer system of any of clauses 1-3, further comprising: a first pole piece connected to the first end of the magnet; and a second pole piece connected to the second end of the magnet, wherein the magnetic flux flows through the magnet from the second pole piece to the first pole piece and flows through a magnetic return path from the first pole piece to the second pole piece.
Clause 5: The accelerometer system of clause 4, further comprising: an excitation ring, wherein the first pole piece is connected to the first end of the magnet, wherein the second pole piece is connected to the second end of the magnet, and wherein the magnetic flux flows through the magnet from the second pole piece to the first pole piece and flows through the excitation ring to from the second pole piece to the first pole piece.
Clause 6: The accelerometer system of any of clauses 1-5, wherein the magnet extends along a longitudinal axis from a first end of the magnet to a second end of the magnet, and wherein the proof mass extends through the magnet normal to the longitudinal axis.
Clause 7: The accelerometer system of any of clauses 1-6, wherein to receive the signal, the processing circuitry is configured to: receive a first signal component corresponding to a first gap between the magnet and the proof mass, wherein the first gap is located at a first side of the proof mass; and receive a second signal component corresponding to a second gap between the magnet and the proof mass, wherein the second gap is located at a second side of the proof mass. The processing circuitry is further configured to: determine a difference between the first signal component and the second signal component, wherein the difference between the first signal component and the second signal component indicates that the proof mass is displaced from the null position; select one or more parameters of the first current based on the difference between the first signal component and the second signal component; and select one or more parameters of the second current based on the difference between the first signal component and the second signal component.
Clause 8: The accelerometer system of any of clauses 1-7, wherein the processing circuitry is further configured to identify, based on the first current and the second current, an acceleration of the accelerometer system.
Clause 9: The accelerometer system of clause 8, wherein the acceleration of the accelerometer system identified by the processing circuitry represents an acceleration along a longitudinal axis of the magnet extending from the first end of the magnet to the second end of the magnet.
Clause 10: The accelerometer system of any of clauses 1-9, wherein a magnitude of the first current is the same as a magnitude of the second current, and wherein a direction of the first current is opposite a direction of the second current.
Clause 11: The accelerometer system of any of clauses 1-10, wherein the first coil is connected to the second coil to form a single current pathway, and wherein first current and the second current form a single current flowing through the single current pathway.
Clause 12: An accelerometer system includes a magnet having a first end and a second end opposite the first end, wherein the magnet is configured to generate a magnetic flux that flows through the magnet from the second end of the magnet to the first end of the magnet; a proof mass extending through the magnet; and a coil disposed around a portion of the magnet. The accelerometer system also includes processing circuitry configured to: receive a signal corresponding to a capacitance of an interface between the magnet and the proof mass; and cause, based on the signal, a current to flow through the coil, wherein a force corresponding to the magnetic flux and the current maintain the proof mass in a null position.
Clause 13: The accelerometer system of clause 12, wherein the magnet has a minor loop slope representing a relationship between a magnetic field strength of the magnet and a magnetization of the magnet.
Clause 14: The accelerometer system of any of clauses 12-13, further comprising a pole piece connected to the first end of the magnet, wherein the magnetic flux flows through the magnet to the pole piece and flows through a magnetic return path from the pole piece to the magnet.
Clause 15: The accelerometer system of clause 14, further comprising: an excitation ring, wherein the pole piece is connected to the first end of the magnet, and wherein the magnetic flux flows through the magnet to the pole piece and flows through the excitation ring to the magnet.
Clause 16: The accelerometer system of any of clauses 12-15, wherein the magnet extends along a longitudinal axis from a first end of the magnet to a second end of the magnet, and wherein the proof mass extends through the magnet normal to the longitudinal axis.
Clause 17: The accelerometer system of any of clauses 12-16, wherein to receive the signal, the processing circuitry is configured to: receive a signal component corresponding to a gap between the magnet and the proof mass, wherein the gap is located at a first side of the proof mass, wherein the processing circuitry is further configured to select one or more parameters of the current based on the signal component.
Clause 18: The accelerometer system of any of clauses 12-17, wherein the processing circuitry is further configured to identify, based on the current, an acceleration of the accelerometer system.
Clause 19: The accelerometer system of clause 18, wherein the acceleration of the accelerometer system identified by the processing circuitry represents an acceleration along a longitudinal axis of the magnet extending from the first end of the magnet to the second end of the magnet.
Clause 20: A method includes receiving, by processing circuitry, a signal corresponding to a capacitance of an interface between a magnet and a proof mass, the magnet having a first end and a second end opposite the first end, wherein the magnet is configured to generate a magnetic flux that flows through the magnet from the second end of the magnet to the first end of the magnet, wherein the proof mass extends through the magnet, wherein a first coil is disposed around a first portion of the magnet, and wherein a second coil is disposed around a second portion of the magnet. The method also includes causing, by the processing circuitry based on the signal, a first current to flow through the first coil; and causing, by the processing circuitry based on the signal, a second current to flow through the second coil. A first force corresponding to the magnetic flux and the first current and a second force corresponding to the magnetic flux and the second current may maintain the proof mass in a null position.

In one or more examples, the accelerometers described herein may utilize hardware, software, firmware, or any combination thereof for achieving the functions described. Those functions implemented in software may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure.

Instructions may be executed by one or more processors within the accelerometer or communicatively coupled to the accelerometer. The one or more processors may, for example, include one or more DSPs, general purpose microprocessors, application specific integrated circuits ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for performing the techniques described herein. Also, the techniques could be fully implemented in one or more circuits or logic elements.

The techniques of this disclosure may be implemented in a wide variety of devices or apparatuses that include integrated circuits (ICs) or sets of ICs (e.g., chip sets). Various components, modules, or units are described in this disclosure to emphasize functional aspects of devices configured to perform the disclosed techniques, but do not necessarily require realization by different hardware units. Rather, various units may be combined or provided by a collection of interoperative hardware units, including one or more processors as described above, in conjunction with suitable software and/or firmware.

What is claimed is:

1. An accelerometer system comprising:
a magnet having a first end and a second end opposite the first end, wherein the magnet is configured to generate a magnetic flux that flows through the magnet from the second end of the magnet to the first end of the magnet;
a proof mass extending through the magnet;
a first coil disposed around a first portion of the magnet;
a second coil disposed around a second portion of the magnet; and
processing circuitry configured to:
receive a signal corresponding to a capacitance of an interface between the magnet and the proof mass;
cause, based on the signal, a first current to flow through the first coil; and
cause, based on the signal, a second current to flow through the second coil,
wherein a first force corresponding to the magnetic flux and the first current and a second force corresponding to the magnetic flux and the second current maintain the proof mass in a null position.

2. The accelerometer system of claim 1, wherein the magnet has a minor loop slope representing a relationship between a magnetic field strength of the magnet and a magnetization of the magnet, and wherein the minor loop slope of the magnet is the same at the first portion of the magnet and the second portion of the magnet.

3. The accelerometer system of claim 1, wherein the first current flows through the first coil in a first direction, and wherein the second current flows through the second coil in a second direction opposite the first direction.

4. The accelerometer system of claim 1, further comprising:
a first pole piece connected to the first end of the magnet; and
a second pole piece connected to the second end of the magnet, wherein the magnetic flux flows through the magnet from the second pole piece to the first pole piece and flows through a magnetic return path from the first pole piece to the second pole piece.

5. The accelerometer system of claim 4, further comprising:
an excitation ring,
wherein the first pole piece is connected to the first end of the magnet,
wherein the second pole piece is connected to the second end of the magnet, and
wherein the magnetic flux flows through the magnet from the second pole piece to the first pole piece and flows through the excitation ring to from the second pole piece to the first pole piece.

6. The accelerometer system of claim 1,
wherein the magnet extends along a longitudinal axis from a first end of the magnet to a second end of the magnet, and
wherein the proof mass extends through the magnet normal to the longitudinal axis.

7. The accelerometer system of claim 1, wherein to receive the signal, the processing circuitry is configured to:
receive a first signal component corresponding to a first gap between the magnet and the proof mass, wherein the first gap is located at a first side of the proof mass; and
receive a second signal component corresponding to a second gap between the magnet and the proof mass, wherein the second gap is located at a second side of the proof mass, and
wherein the processing circuitry is further configured to:
determine a difference between the first signal component and the second signal component, wherein the difference between the first signal component and the second signal component indicates that the proof mass is displaced from the null position;
select one or more parameters of the first current based on the difference between the first signal component and the second signal component; and
select one or more parameters of the second current based on the difference between the first signal component and the second signal component.

8. The accelerometer system of claim 1, wherein the processing circuitry is further configured to identify, based on the first current and the second current, an acceleration of the accelerometer system.

9. The accelerometer system of claim 8, wherein the acceleration of the accelerometer system identified by the processing circuitry represents an acceleration along a longitudinal axis of the magnet extending from the first end of the magnet to the second end of the magnet.

10. The accelerometer system of claim 1, wherein a magnitude of the first current is the same as a magnitude of the second current, and wherein a direction of the first current is opposite a direction of the second current.

11. The accelerometer system of claim 1, wherein the first coil is connected to the second coil to form a single current pathway, and wherein first current and the second current form a single current flowing through the single current pathway.

12. An accelerometer system comprising:
a magnet having a first end and a second end opposite the first end, wherein the magnet is configured to generate a magnetic flux that flows through the magnet from the second end of the magnet to the first end of the magnet;
a proof mass extending through the magnet;
a coil disposed around a portion of the magnet; and
processing circuitry configured to:
receive a signal corresponding to a capacitance of an interface between the magnet and the proof mass; and
cause, based on the signal, a current to flow through the coil, wherein a force corresponding to the magnetic flux and the current maintain the proof mass in a null position.

13. The accelerometer system of claim 12, wherein the magnet has a minor loop slope representing a relationship between a magnetic field strength of the magnet and a magnetization of the magnet.

14. The accelerometer system of claim 12, further comprising a pole piece connected to the first end of the magnet, wherein the magnetic flux flows through the magnet to the pole piece and flows through a magnetic return path from the pole piece to the magnet.

15. The accelerometer system of claim 14, further comprising:
an excitation ring,
wherein the pole piece is connected to the first end of the magnet, and
wherein the magnetic flux flows through the magnet to the pole piece and flows through the excitation ring to the magnet.

16. The accelerometer system of claim 12,
wherein the magnet extends along a longitudinal axis from a first end of the magnet to a second end of the magnet, and
wherein the proof mass extends through the magnet normal to the longitudinal axis.

17. The accelerometer system of claim 12, wherein to receive the signal, the processing circuitry is configured to:
receive a signal component corresponding to a gap between the magnet and the proof mass, wherein the gap is located at a first side of the proof mass,
wherein the processing circuitry is further configured to select one or more parameters of the current based on the signal component.

18. The accelerometer system of claim 12, wherein the processing circuitry is further configured to identify, based on the current, an acceleration of the accelerometer system.

19. The accelerometer system of claim 18, wherein the acceleration of the accelerometer system identified by the processing circuitry represents an acceleration along a longitudinal axis of the magnet extending from the first end of the magnet to the second end of the magnet.

20. A method comprising:
receiving, by processing circuitry, a signal corresponding to a capacitance of an interface between a magnet and a proof mass,
the magnet having a first end and a second end opposite the first end, wherein the magnet is configured to generate a magnetic flux that flows through the magnet from the second end of the magnet to the first end of the magnet,
wherein the proof mass extends through the magnet,
wherein a first coil is disposed around a first portion of the magnet, and
wherein a second coil is disposed around a second portion of the magnet;
causing, by the processing circuitry based on the signal, a first current to flow through the first coil; and
causing, by the processing circuitry based on the signal, a second current to flow through the second coil,
wherein a first force corresponding to the magnetic flux and the first current and a second force corresponding to the magnetic flux and the second current maintain the proof mass in a null position.
